(19) United States
(12) Patent Application Publication
(10) Pub. No.: US 2009/0062455 A1
(43) Pub. Date: Mar. 5, 2009

(54) Rubber Composition For Tire And Its Producing Method

(75) Inventors: Hiroaki Narita, Osaka (JP); Ikuo Ihara, Osaka (JP); Takashi Miyasaka, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/192,204

(22) Filed: Aug. 15, 2008

(30) Foreign Application Priority Data
Aug. 27, 2007 (JP) 2007-219616

(51) Int. Cl. C08L 9/00

(52) U.S. Cl. 524/571; 525/348

(57) ABSTRACT

A rubber composition for tire, which combines low heat build-up properties and breakage property, reduces fuel consumption of a tire, and has excellent good processability is provided. The rubber composition for tire is obtained by blending sulfur and caprolactam disulfide with a diene rubber component to obtain a pre-mixture which does not contain a reinforcing filler and a vulcanization accelerator, and blending and mixing a reinforcing filler and a vulcanization accelerator with the pre-mixture in a post-mixing step.

### CROSS-REFERENCE TO RELATED APPLICATIONS

This application is based upon and claims the benefit of priority from the prior Japanese Patent Application No. 2007-219616, filed on Aug. 27, 2007; the entire contents of which are incorporated herein by reference.

### BACKGROUND

The present invention relates to a rubber composition for tire, and more particularly it relates to a rubber composition for tire, that can improve processability and heat build-up properties of a rubber composition.

In recent years, the demand for low fuel consumption of automobiles is increasing, and reduction of rolling resistance of a tire is strongly demanded. It is known that rolling resistance is related to heat build-up properties of a rubber composition, and it is effective to reduce hysteresis loss of a rubber, that is, to suppress loss factor (tan δ) of a rubber composition low.

Various technologies for suppressing heat build-up properties of a rubber composition are proposed. For example, JP-A-2005-146076 discloses a rubber composition for side tread, comprising 100 parts by weight of a vulcanizable rubber containing 65% by weight or more of a natural rubber and a polybutadiene rubber, 30 to 80 parts by weight of the total of silica and/or carbon black having a nitrogen adsorption specific surface area (N₂SA) of 20 to 85 m²/g, and 0.1 to 10 parts by weight of a specific cyclic polysulfide, the composition having high hardness, strength and elongation, and suppressing rise of tan δ.

JP-A-2006-151259 discloses that a rubber composition containing a modified natural rubber obtained by graft-polymerizing a polar group-containing monomer on a natural rubber latex, and solidifying and drying it, the composition having both of excellent low heat build-up and high breakable resistance properties.

A rubber composition for tire is required to have low heat build-up and high breakage property. A method for suppressing heat build-up of a rubber composition in a formulation mainly comprising a diene rubber component such as a natural rubber is conventionally investigated. When a proportion of a natural rubber is increased, breakage strength is improved, but there is a tendency that low heat build-up properties are not obtained. Thus, it was difficult to combine low heat build-up properties and breakage property in high level.

### SUMMARY

In view of the above point, the present invention provides a rubber composition for tire, which combines low heat build-up properties and breakage property, reduces fuel consumption of a tire, and has excellent processability, in the blending of a diene rubber such as a natural rubber component.

The present invention has been made based on the finding that heat build-up properties of a rubber composition can be improved, while having excellent processability, by using a pre-mixture obtained by previously and simultaneously mixing sulfur and a specific disulfide vulcanizing agent with a diene rubber component, and blending a reinforcing filler and a vulcanization accelerator in the subsequent mixing step.

The present invention relates to a rubber composition for tire, obtained by blending sulfur and caprolactam disulfide with a diene rubber component to obtain a pre-mixture which does not contain a reinforcing filler and a vulcanization accelerator, and blending and mixing a reinforcing filler and a vulcanization accelerator with the pre-mixture in a post-mixing step.

In the rubber composition of the present invention, it is preferred that the pre-mixture contains 0.1 to 1.0 part by weight of the sulfur and 0.1 to 5.0 parts by weight of the caprolactam disulfide per 100 parts by weight of the diene rubber component.

According to the present invention, there can be provided a rubber composition for tire, which achieves both low heat build-up and breakage property to reduce fuel consumption of a tire, and has excellent processability, in the blending of the diene rubber such as a natural rubber component.

### DETAILED DESCRIPTION

The rubber composition for tire of the present invention is obtained by blending a diene rubber component, sulfur and caprolactam disulfide and mixing those without addition of a reinforcing filler and a vulcanization accelerator to obtain a pre-mixture in a first mixing step (pre-mixing), and adding other additives including a reinforcing filler and a vulcanization accelerator to the pre-mixture, followed by mixing the resulting mixture, in a mixing step of a second mixing step or later.

Examples of the diene rubber used as a rubber component include natural rubbers, and diene synthetic rubbers such as an isoprene rubber, a butadiene rubber or a styrene-butadiene rubber. Those may be used alone or as mixtures of two or more thereof in optional proportions.

In the present invention, the rubber component contains the natural rubber or isoprene rubber in an amount of preferably 50 parts by weight or more, and more preferably 60 parts by weight ore more, per 100 parts by weight of the rubber component. This makes it easy to ensure properties such as breakage strength, abrasion resistance or fatigue resistance of the rubber composition.

Examples of the sulfur include powdered sulfur, precipitated sulfur, colloidal sulfur, insoluble sulfur and oil-treated sulfur. Those sulfurs may be used as mixtures of two or more thereof.

The caprolactam disulfide used in the rubber composition of the present invention is, for example, a compound represented by the following formula (I):

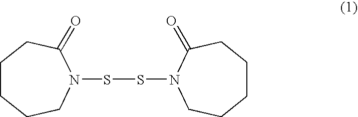

The commercially available product, RHENOGRAN CLD-80, a product of Rhein Chemie, can be used as the caprolactam disulfide.

used in the rubber composition of the present invention.

Blending the caprolactam disulfide in a pre-mixing stage makes it easy to cut double bonds in a polymer and makes the processability good, and simultaneously, heat build-up properties can be improved.

The addition time of the caprolactam disulfide is not limited so long as it is not simultaneously added together with other vulcanization accelerators in the pre-mixing stage. The reason for this is that when the caprolactam disulfide and the vulcanization accelerator are simultaneously added in the pre-mixing, crosslinking reaction proceeds in the pre-mixing, and improvement in heat build-up properties is not obtained.

Furthermore, when the reinforcing filler such as carbon black or silica is added in the pre-mixing stage, the caprolactam disulfide and the filler are reacted and bonded to cure a rubber mixture, resulting in deterioration of kneadability or processability, and additionally, the polymer and the filler are reacted, and heat build-up properties tend to deteriorate by modification of the polymer surface.

It is preferred in the present invention that the rubber mixture obtained in the pre-mixing step contains 0.1 to 1.0 part by weight of the sulfur, and 0.1 to 5.0 parts of the caprolactam disulfide per 100 parts by weight of the diene rubber component.

When only the rubber component and the sulfur are mixed, improvement effect on heat build-up properties and processability are not obtained. The improvement effect on heat build-up properties and processability is developed by simultaneously adding and mixing the caprolactam disulfide.

When the amount of the sulfur added is less than 0.1 part by weight, the improvement effect on processability is not exhibited, and when the amount exceeds 1.0 part by weight, there is a great possibility that crosslinking reaction begins due to heat build-up during kneading. Furthermore, when the amount of the caprolactam disulfide added is less than 0.1 part by weight, improvement effect on heat build-up properties and processability is insufficient, and when the amount exceeds 5.0 parts by weight, heat build-up properties are good, but rubber hardness of a rubber mixture is increased, causing deterioration of rubber properties such as breakage property of the final rubber composition.

As the vulcanization accelerator added and mixed in the mixing step of the second mixing step or later of the invention, any vulcanization accelerator can be used without limiting its kind. Examples of the vulcanization accelerator that can be used include sulfene amide type vulcanization accelerators such as N-cyclohexyl-2-benzothiazylsulfene amide (CZ), N-tert-butylbenzothiazole-2-sulfene amide (NS) and N-oxydiethylene-2-benzothiazolesulfene amide (OBS); thiuram type vulcanization accelerators such as tetramethylthiuram disulfide (TT) and tetrabutylthiuram disulfide (TBT); aldehyde/ammonia type vulcanization accelerators such as hexamethylene tetramine; guanidine type vulcanization accelerators such as 1,3-diphenylguanidine (D); and thiazole type vulcanization accelerators such as 2-mercaptobenzothiazole (M) and dibenzothiadyldisulfide (DM).

The vulcanization accelerator is used in an amount of about 0.3 to 5 parts by weight, and preferably 0.5 to 3 parts by weight, per 100 parts by weight of the rubber component. When the amount of the vulcanization accelerator used is less than 0.3 part by weight, vulcanization rate becomes slow, resulting in decrease of productivity, and when the amount exceeds 5 parts by weight, scorch is liable to occur. The vulcanization accelerator may be used as mixtures of two or more thereof.

Examples of the reinforcing filler used in the rubber composition of the present invention include fillers such as carbon black, silica, calcium carbonate, clay and talc.

The carbon black used is not particularly limited. For example, carbon black having colloidal properties of nitrogen adsorption specific area (N₂SA) of 25 to 130 m²/g and DBP oil absorption of 80 ml/100 g or more can be used.

Examples of such a carbon black include various grades of N110, N220, N330, N550 or N660 in ASTM number.

The amount of the carbon black blended is about 20 to 80 parts by weight per 100 parts by weight of the rubber component. When the amount of the carbon black blended is less than 20 parts by weight, the reinforcing effect is deficient, and breakage property and abrasion resistance are decreased. On the other hand, when the amount exceeds 80 parts by weight, heat build-up properties deteriorate, and the processability is decreased.

Examples of the preferred silica include silica having colloidal properties of BET specific surface area (BET) of 150 m²/g or less and DBP oil absorption of 190 ml/100 g or less. Using such silica having a large particle diameter and a small structure can maintain processability, and additionally can suppress heat build-up properties, thereby reducing rolling resistance.

The amount of silica blended is about 10 to 50 parts by weight per 100 parts by weight of the rubber component. When the amount of silica blended is less than 10 parts by weight, the effect of reducing rolling resistance cannot sufficiently be exhibited. The preferred amount of silica blended is 20 to 40 parts by weight.

The silica is not particularly limited so long as the above colloidal properties are satisfied. Examples of the silica used include wet silica (hydrous silicic acid), dry silica (anhydrous silicic acid), calcium silicate and aluminum silicate. Above all, wet silica having both of breakage property and low rolling resistance is preferred, and such is further preferred from the point of excellent productivity. Commercially available products such as NIPSEAL AQ, a product of Tosoh Silica Corporation, and TOKUSEAL, a product of Tokuyama Corp., can be used.

As the silica, further a surface-treated silica obtained by surface-treatment with amines or organic polymers to improve affinity for a polymer can be used.

When silica is used, it is preferred to use a silane coupling agent in an amount of 2 to 20% by weight, and preferably 2 to 15% by weight, based on the weight of the silica. Examples of the silane coupling agent used include sulfur-containing silane coupling agents such as bis(3-triethoxysilylpropyl)tetrasulfide and bis(3-triethoxysilylpropyl)disulfide; and 3-trimethoxysilylpropylbenzothiazole tetrasulfide.

In addition to the above components, the rubber composition of the present invention can contain various additives such as process oils, zinc oxide, stearic acid, waxes, aging inhibitors, vulcanization aids or resins, that are generally used in a tire industry, according to need in an amount such that the advantage of the invention is not impaired.

The rubber composition for tire of the present invention as above is prepared by the conventional methods using kneading machines for rubber such as Banbury mixer or a kneader.

Specifically, in a first mixing step (A), the diene rubber component, the sulfur and the caprolactam disulfide are kneaded to prepare a pre-mixture (masterbatch). In a second mixing step (B), a rubber component, the sulfur or the caprolactam disulfide to be additionally added to the masterbatch if necessary, the reinforcing filler such as carbon black, and other additive such as zinc oxide, aging inhibitor or stearic acid are added to the masterbatch and the resulting mixture is kneaded. In a third mixing step (C), a rubber component, the sulfur or the caprolactam disulfide to be further additionally added if necessary, the vulcanization accelerator and a scorch inhibitor are added to the mixture prepared above, and the resulting mixture is kneaded. Thus, a final rubber composition is prepared. Furthermore, the above step (B) and step (C) can be conducted in the same step, thereby preparing the final mixture in two steps.

The rubber composition for tire obtained by the present invention is not particularly limited in its use, and can be applied to each site of a tire, such as a tread part, a side wall part, a bead part or a rubber for covering a tire cord, of pneumatic tires for various uses and having various sizes, such as tires for passenger cars or large-sized tires for tracks or buses.

### EXAMPLES

The present invention is described by the following Examples, but the invention is not limited to those Examples.

100 parts by weight of the total of a natural rubber and a butadiene rubber, and the blending components shown below were kneaded according to the formulation (parts by weight) shown in Table 1 using a 1.7 liters volume sealed Banbury mixer to prepare a masterbatch in a pre-mixing step. Using this masterbatch, a rubber composition was prepared with a 1.7 liters volume sealed Banbury mixer by a general mixing step (second mixing step).

### Rubber Component

Natural rubber: STR20

Butadiene rubber: JSR BR01, a product of JSR Corporation

### Blending Component

Sulfur: 5% oil-treated powdered sulfur, a product of Tsurumi Chemical Co., Ltd.

Caprolactam disulfide: RHENOGRAN CLD-80, a product of Rhein Chemie

Carbon black: SHOW BLACK N220, a product of Showa Cabot K.K.

Vulcanization accelerator CZ: SOXINOL CZ, a product of Sumitomo Chemical Co., Ltd.

As the common blending components, 3 parts by weight of zinc oxide: Zinc White #1, a product of Mitsui Mining & Smelting Co., Ltd.; 1.4 parts by weight of an aging inhibitor: ANTIGEN 6C, a product of Sumitomo Chemical Co., Ltd.; 1 part by weight of stearic acid: LUNAX S-25, a product of Kao Corporation; 0.5 part by weight of a wax: OKERIN 2122H, a product of Honeywell; and 0.2 part by weight of a scorch inhibitor: SANTOGARD PVI, a product of Sanshin Chemical Industry Co., Ltd., were blended with the rubber composition of each Example and Comparative Example.

Regarding each rubber composition obtained, Mooney viscosity as an index of processability, 300% modulus as an index of breakage property and tan δ as an index of heat build-up properties were evaluated by the following methods. The results obtained are shown in Table 1.

### Mooney Viscosity

Mooney viscosity (ML₁₊₄, 120° C.) was measured according to JIS K6300, and indicated in a relative value of the result of Comparative Example 1 being 100. Smaller values mean better results.

### 300% Modulus

Measured by a tensile test (using No. 3 Dumbbell) according to JIS K6251, and indicated in a relative value of the result of Comparative Example 1 being 100. Larger values mean better results.

### Tan δ

Measured under the conditions of frequency of 50 Hz, dynamic strain of 2% and 80° C. using RHEOSPECTROMETER E-4000, a product of UMB, and indicated in a relative value of the result of Comparative Example 1 being 100. Smaller values mean smaller heat build-up and better results.

TABLE 1

| | | Com. | Com. | Com. | Com. | | | | | |
|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex. 5 |
| Pre-mixing | Natural rubber | Pre-mixing: | Pre-mixing: | Pre-mixing: | Pre-mixing: | 100 | 100 | 100 | 100 | 80 |
| | Butadiene rubber | None | None | None | None | | | | | 20 |
| | Sulfur | | | | | 0.5 | 0.5 | 0.25 | 0.25 | 0.5 |
| | Caprolactam disulfide | | | | | 2 | 1 | 2 | 1 | 2 |
| General | Natural rubber | 100 | 100 | 100 | 100 | *1 | *1 | *1 | *1 | *1 |
| mixing | Carbon black | 40 | 40 | 40 | 40 | 40 | 40 | 40 | 40 | 40 |
| | Vulcanization | 1.3 | 1.0 | 1.1 | 1.2 | 1.3 | 1.1 | 1.3 | 1.1 | 1.3 |
| | accelerator | | | | | | | | | |
| | Sulfur | 1.6 | 1.6 | 1.6 | 1.6 | 1.6 | 1.6 | 1.6 | 1.6 | 1.6 |
| | Caprolactam disulfide | | 2.0 | 1.0 | 0.5 | | | | | |
| Results | Mooney viscosity | 100 | 94 | 97 | 97 | 88 | 88 | 90 | 91 | 84 |
| | (relative value) | | | | | | | | | |
| | 300% modulus | 100 | 102 | 100 | 98 | 125 | 99 | 101 | 102 | 113 |
| | (relative value) | | | | | | | | | |
| | tan δ (relative value) | 100 | 103 | 105 | 107 | 79 | 86 | 81 | 88 | 76 |

*1: Masterbatch obtained in pre-mixing step was used.

As is seen from Table 1, the Examples according to the present invention can maintain Mooney viscosity low, making processability good, can improve or maintain breakage property, and can greatly improve heat build-up properties.

The rubber composition for tire of the present invention can be applied to each site of a tire, such as a tread part, a side wall part, a bead part or a rubber for covering a tire cord, of pneumatic tires for various uses and having various sizes.

What is claimed is:

1. A rubber composition for tire, obtained by blending sulfur and caprolactam disulfide with a diene rubber component to obtain a pre-mixture which does not contain a reinforcing filler and a vulcanization accelerator, and blending and mixing a reinforcing filler and a vulcanization accelerator with the pre-mixture in a post-mixing step.

2. The rubber composition for tire as claimed in claim 1, wherein the pre-mixture contains 0.1 to 1.0 part by weight of the sulfur and 0.1 to 5.0 parts by weight of the caprolactam disulfide per 100 parts by weight of the diene rubber component.

3. A method for producing a rubber composition for tire, comprising blending sulfur and caprolactam disulfide with a diene rubber component to obtain a pre-mixture which does not contain a reinforcing filler and a vulcanization accelerator, and blending and mixing a reinforcing filler and a vulcanization accelerator with the pre-mixture in a post-mixing step.

4. The method for producing a rubber composition for tire as claimed in claim 3, wherein the pre-mixture contains 0.1 to 1.0 part by weight of the sulfur and 0.1 to 5.0 parts by weight of the caprolactam disulfide per 100 parts by weight of the diene rubber component.
